(19) United States
(12) Patent Application Publication
(10) Pub. No.: US 2003/0047388 A1
(43) Pub. Date: Mar. 13, 2003

(54) Scissors lifter drive apparatus

(76) Inventor: William M. Faitel, New Baltimore, MI (US)

Correspondence Address: REISING ETHINGTON BARNES KISSELLE, LEARMAN AND MCCULLOCH PC, P O BOX 4390, TROY, MI, 48099-4390, US

(21) Appl. No.: 09/943,544

(22) Filed: Aug. 30, 2001

(51) Int. Cl. B66F 7/14; B66F 7/06

(52) U.S. Cl. 187/214; 187/267; 187/211; 187/269

(57) ABSTRACT

A scissors lift with a drive apparatus that raises and lowers a load platform by extending and collapsing a scissors linkage. A drive motor moves a cam follower through generally horizontal reciprocal motion. The cam follower engages and follows a cam mounted on the scissor linkage to extend the scissor linkage. The cam is positioned and shaped to gradually accelerate and decelerate scissor linkage extension. The cam is also shaped to allow the drive motor to accelerate to an optimum desired operating speed before causing the drive motor to bear the load of extending the first scissor linkage and raising the load platform.

### CROSS-REFERENCES TO RELATED APPLICATIONS

Not Applicable Statement Regarding Federally Sponsored Research or Development

Not Applicable

### BACKGROUND OF THE INVENTION

1. Field of the Invention

This invention relates generally to a scissors lifter drive apparatus for raising and lowering a load platform by extending and collapsing a scissors linkage.

2. Description of the Related Art Including Information Disclosed Under 37 CFR 1.97 and 1.98

Scissors lifters that raise and lower load platforms by extending and collapsing scissors linkages are well known in the art. A scissors lifter will typically include a load platform supported for reciprocal vertical movement on a pair of parallel scissor linkages. Each of the scissor linkages includes one or more vertically-interconnected crossed scissor arm pairs. The arms of each scissor arm pair are connected together at respective approximate midpoints for pivotal movement about a common scissor axis. An upper end of one arm of an uppermost scissor arm pair of each scissor linkage is pivotally connected to the load platform. The upper supported on the load platform for horizontal reciprocal movement toward and away from the upper end of the pivotally-connected arm and perpendicular to the scissor axis. A lower end of one arm of a lowermost scissor arm pair of each linkage is pivotally connected to a base. A lower end of the other arm of the lowermost scissor arm pair of each linkage is connected to and supported on the base for horizontal reciprocal movement toward and away from the lower end of the pivotally connected arm and perpendicular to the scissor axis. The platform is raisable and lowerable by moving the horizontally slidable ends of each scissor arm pair toward and away from the pivotally connected ends of each scissor arm pair, respectively, thus extending and collapsing the two scissor linkages.

Scissors lifters may be hand-operated by a crank or may include driving units. The driving units may be either low cost driving units such as constant speed motors or more expensive variable speed drive motors or servo motors. With low cost driving units it's difficult to control the extension and collapse of a scissors lifter. The abrupt starting and stopping of the lifter drive results in shock loads that cause the lifter and load platform to sway, shake and/or vibrate. In applications requiring the accurate positioning of workpieces supported on a scissors lifter load platform, this presents a significant problem. As a result, to allow for the use of lower cost driving units, cams are sometimes incorporated into scissor lifters to control the acceleration and deceleration of scissor lifter extension and collapse.

For example, U.S. Pat. No. 3,556,481 issued Jan. 19, 1971 to Mueller, discloses a scissors lifter that includes a load platform supported for reciprocal vertical movement on a pair of parallel scissor linkages. Each scissor linkage includes a single pair of crossed scissor arms. An upper end of a first one of the arms of the crossed scissor arms of each scissor linkage is pivotally connected to the load platform. The upper end of a second arm of the crossed scissor arms of each linkage is connected to and supported on the load platform for horizontal reciprocal movement toward and away from the upper end of the first arm. A lower end of the second arm of the crossed scissor arms of each linkage is pivotally connected to a base. A lower end of the first arm of the crossed scissor arms of each link is connected to and supported on the base for horizontal reciprocal movement toward and away from the lower end of the first arm.

The Mueller patent also discloses a scissor lifter drive that includes two rolling cam followers supported on a carriage for generally horizontal reciprocal motion perpendicular to scissors axes of the scissor linkages. The cam followers engage the respective linkages in a lateral wedging action between the crossed arms of the respective scissor linkages to extend the scissor linages. The carriage is driven by an air cylinder connected to the carriage.

The Mueller drive also includes two cams, each mounted on one of the arms of the scissor linkages in a position to be drivingly engaged by one of the cam followers. The cams are shaped to gradually accelerate scissor linkage extension and to gradually decelerate linkage collapse to accommodate the commencement of wedging action between the crossed scissor arms of the scissors linkages during scissor linkage extension.

The scissors lifter drive apparatus disclosed in the Mueller patent also includes an auxiliary locking mechanism that locks the cam followers in various platform-elevating positions to prevent collapse of the jack under load should the drive fail to hold the cam followers in those positions.

Also, U.S. Pat. No. 2,862,689 issued Dec. 2, 1958 to Dalrymple et al., discloses a scissors lifter drive apparatus including cams mounted on respective arms of a scissors lifter and cam followers that act on curved surfaces of the cams. The curved surfaces of the cams are shaped as semi-circular arcs “so that elevation of the lift is achieved by the application of uniform pressure”.

A scissors lifter drive apparatus constructed according to the above patents would inflict significant wear on a low-cost constant speed drive motor because it would cause the motor to bear the load of lifting the load platform before allowing the motor to accelerate to its optimum operating speed.

### BRIEF SUMMARY OF THE INVENTION

The invention is a scissors lifter drive apparatus for raising and lowering a load platform by extending and collapsing a scissors linkage. The apparatus comprises a scissors lifter including a load platform supported for reciprocal vertical movement on a first scissor linkage. The platform is raised and lowered by extending and collapsing the scissor linkage. A rolling cam follower is supported for generally horizontal reciprocal motion and is drivingly engageable with the first scissor linkage to extend the first scissor linkage. The scissors lifter drive apparatus also includes a cam mounted on the first scissor linkage in a position to be drivingly engaged by the first cam follower. The first cam is positioned and shaped to gradually accelerate extension of the first scissor linkage. A drive is connected to the first cam follower and is configured to move the first cam follower through generally horizontal reciprocal motion. The first cam is shaped to allow the drive to accelerate to an optimum desired operating speed before causing the drive to bear the load of extending the first scissor linkage and raising the load platform. This allows a simple and inexpensive constant-speed drive motor to be used rather than a more complex and expensive drive mechanism such as a servo motor or variable speed drive motor.

According to another aspect of the invention, the apparatus includes a brake configured to hold the load platform at whatever elevation the load platform is in when the drive motor is turned off. The cam is shaped to allow the drive motor to continue running at a desired operating speed after the first scissor linkage has fully extended.

Objects, features and advantages of this invention include providing a scissors lift drive that uses simple and inexpensive constant-speed drive motors, that obviates the need to use more complex and expensive drive mechanisms such as a servo motors or variable speed drive motors, that reduces motor wear by allowing a drive mechanism such as a constant speed drive motor to reach an optimum operating speed before having to lift a load, and that reduces brake wear by delaying brake engagement until motion at each end of each lift cycle has stopped.

### BRIEF DESCRIPTION OF THE SEVERAL VIEWS OF THE DRAWINGS

These and other objects, features and advantages of this invention will be apparent from the following detailed description of the preferred embodiment(s) and best mode, appended claims, and accompanying drawings in which:

FIG. 1 is a perspective view of a scissors lifter drive apparatus incorporated into a scissors lifter, with the scissors lifter shown in an extended position;

FIG. 2 is a partially cut away front view of the scissors lifter and scissors lifter drive apparatus of FIG. 1 showing the scissors lifter in a retracted position;

FIG. 3 is a plan view of the scissors lifter and scissors lifter drive apparatus of FIG. 1 shown in the extended position and with a load platform of the scissors lifter removed for clarity;

FIG. 4 is a partially cut-away front view of the scissors lifter and scissors lifter drive apparatus of FIG. 1 in the extended position;

FIG. 5 is a graphical representation of a cycloidal curve profile defined by each of two parallel cam roller bearing surfaces of the scissor lifter drive apparatus of FIG. 1; and

FIG. 6 is a graphical representation of the lifted distance of a load platform of the scissor lifter of FIG. 1 over a single two-second lift cycle driven by the scissor lifter drive apparatus of FIG. 1.

### DETAILED DESCRIPTION OF INVENTION EMBODIMENTS

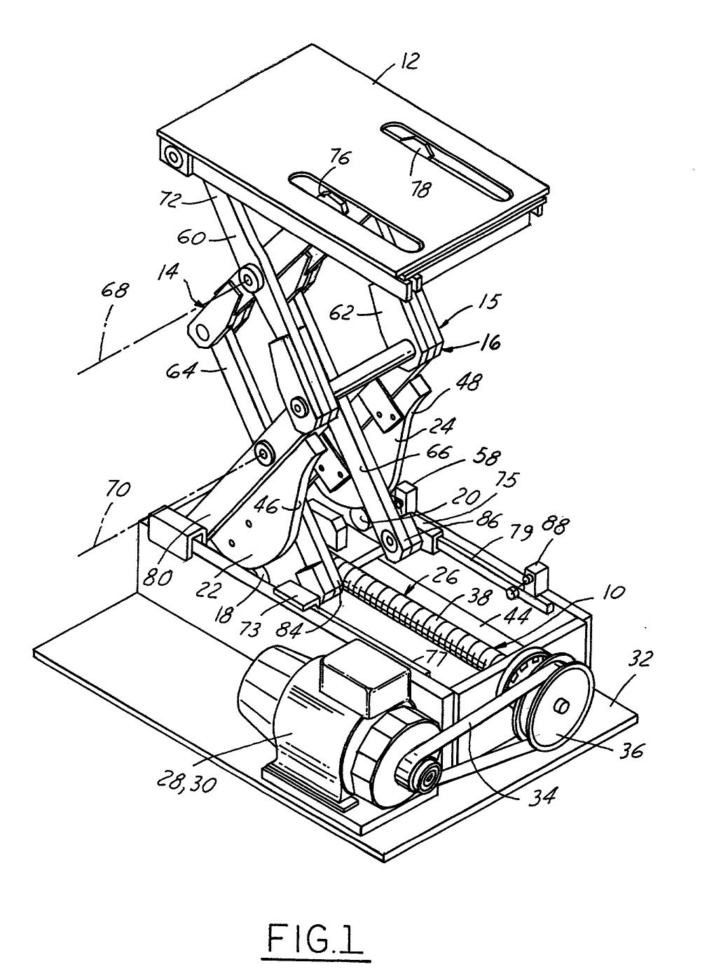

FIG. 1 illustrates a drive apparatus 10 for raising and lowering a load platform 12 by extending and collapsing scissors linkages 14, 15. As shown in FIGS. 1-4, the drive apparatus 10 includes a scissors lifter 16 that supports the load platform 12 for reciprocal vertical movement on a first pair of parallel scissor linkages 14, 15. Two rolling cam followers 18, 20 are supported for horizontal reciprocal motion and are drivingly engageable with the respective scissor linkages 14, 15 to extend the scissor linkages 14, 15. The apparatus 10 also includes two cams 22, 24 with each cam being mounted on one of the scissor linkages 14, 15 in a position to be drivingly engaged by one of the cam followers 18, 20. The cams 22, 24 are positioned and shaped to gradually accelerate and decelerate extension and collapse of the scissor linkages 14, 15 in response to the reciprocal motion of the cam followers 18, 20. A drive 26 is connected to the cam followers 18, 20 and moves the cam followers 18, 20 through generally horizontal reciprocal motion.

The cams 22, 24 are shaped to allow the drive 26 to accelerate to an optimum desired operating speed before causing the drive 26 to bear the load of extending the scissor linkages 14, 15, raising the load platform 12 and lifting whatever load is disposed on the load platform 12. This allows a simple and inexpensive constant speed drive motor 28 to be used to drive the apparatus 10 rather than a more complex and expensive drive mechanism such as a servo motor or variable speed drive motor 28.

As shown in FIGS. 1 and 3, the drive 26 includes a drive motor 28 that is coupled to the cam followers 18, 20 and moves the cam followers 18, 20 through their generally horizontal reciprocal motion. A brake 30 or clutch holds the load platform 12 at whatever elevation the load platform 12 is in when the drive motor 28 is turned off.

The motor 28 may be a standard reversible AC brake motor that incorporates the braking feature. When the drive motor 28 is off, the brake 30 is engaged. When the motor 28 is actuated, the brake 30 is disengaged. Other embodiments may include another standard type of drive motor 28 such as a reversible AC motor with a clutch. In still other embodiments the brake 30 may not be incorporated into the drive motor 28.

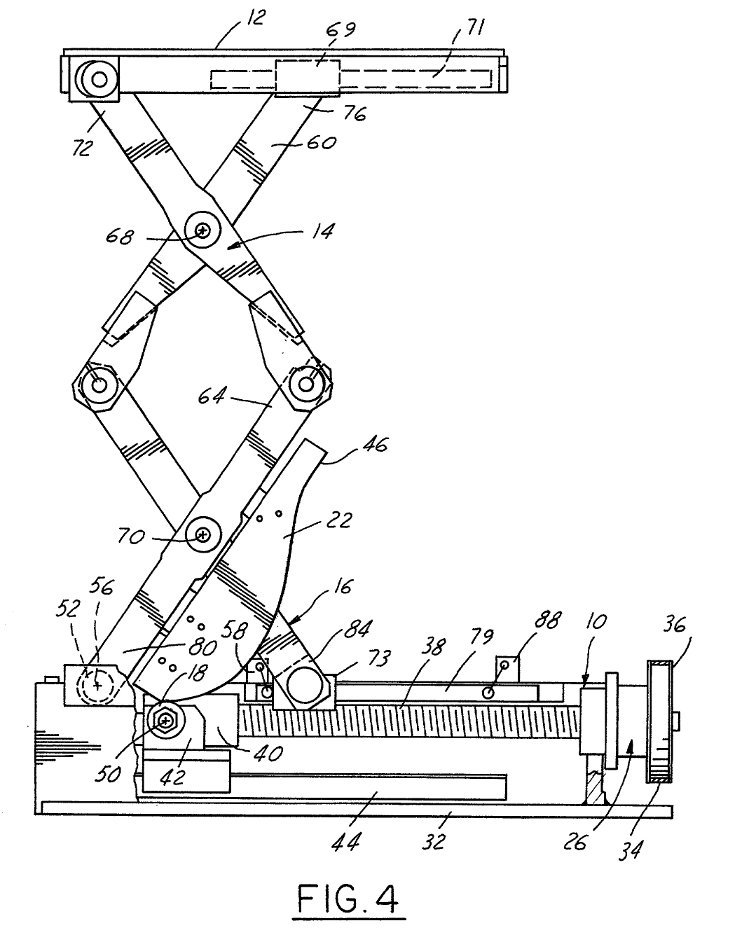

The AC brake motor 28 normally operates at a constant speed. The motor 28 is attached to and supported on a base 32 of the lifter 16 and through a belt 34 and pulley 36 system drives a ball screw shown at 38 in FIG. 1, 3 and 4. The ball screw 38 threadedly engages a ball screw nut 40 attached to a carriage 42 as best shown in FIGS. 3 and 4. The carriage 42 is supported for reciprocal longitudinal movement on the base 32 on a pair of parallel linear guide rails or ways 44. Rotation of the ball screw 38 drives the carriage 42 through its horizontal reciprocal motion on the base 32.

The cam followers 18, 20 are rollers rotatably supported on the carriage 42 in respective positions to engage and roll along the respective cams 22, 24 attached to the scissors linkages 14, 15. Because the motor 28 is a constant speed motor, it drives the carriage 42 back and forth at a generally constant speed. The constant speed that the motor 28 runs at is preferably an optimum operating speed such as the motor's synchronous speed.

The drive 26 imparts a generally cycloidal lift motion to the lift platform 12. To accomplish this, each of the cams 22, 24 includes a cam follower bearing surface 46, 48 that the cam rollers 18, 20 engage and roll along. As is best shown in FIG. 1, each such surface 46, 48 is generally identical to the other and defines a cam profile curve 49 shown graphically in FIG. 5. The cycloidal output motion is defined mathematically as follows:

Xᵢ=Camposᵢ·cos(θᵢ−θᵢₙᵢₜ)

Yᵢ=(−Camposᵢ)·sin(θᵢ−θᵢₙᵢₜ)

where:

Xᵢ and Yᵢ are incremental X and Y values of an orthogonal reference system defining the cam profile;

Camposᵢ is the incremental horizontal position of a common rotational axis 50 of the cam rollers 18 with respect to the time steps;

θᵢₙᵢₜ is the angle of an imaginary harmonic lift arm at the bottom or start of a stroke;

Θᵢ is an incremental angular measurement of the position of the imaginary lift arm from θᵢₙᵢₜ; and

i (the working increment)=0,1. 25

Camposᵢ=Cam_start_pos+CamVel·tᵢ

where:

Cam_{—start}_pos and is the cam starting position, which is the distance, in the x direction, to the cam roller axis 50 from stationary pivots 52, 54 that pivotally connect the scissors linkages 14, 15 to the base 32 but allow for no longitudinal motion.

$$CamVel = \frac{Cam\_travel}{Lift time}$$

and is the velocity of the cam, Cam_travel being the distance from cam start position toward the stationary pivots 52, 54;

t=time in seconds; and

$${t}_{i} = \frac{Lift\_time \cdot i}{25}$$

$$θ init = a sin ( \frac{Start\_height}{Lift\_Lever} )$$

where:

Start_height is the starting height of the load platform 12; and

Lift_Lever is the length of the imaginary harmonic arm. This harmonic arm theoretically extends out from the stationary pivots 52, 54 and represents the actual lever that the scissors linkages 14, 15 are working on. In the example, the lift lever is 48 inches long.

$${θ}_{i} = arc sin [ \frac{( {Lifted\_dis}_{i} + Start\_height )}{Lift\_Lever} ]$$

where:

Lifted_disᵢ is an incremental linear measurement of cycloidal motion indicating what the height of the load platform 12 will be relative to the time step.

Referring to FIG. 5, note that the cam profile curve 49 is actually the path defined by the cam roller axis 50 as the cam rollers 18, 20 move along the cam roller bearing surfaces 46, 48 of the cams 22, 24. The “0” value shown at the upper left hand corner of the graph of FIG. 5 represents the “zero point”—the position of a common centerline or axis 56 extending through both of the stationary pivots 52, 54. There is no vertical load platform 12 motion when the cam rollers 18, 20 are at a point along the cam roller bearing surfaces 46, 48 represented by the left end of curve 49 shown in FIG. 5 because the curve 49, at its left end, is pointing at the zero point. As is also shown in FIG. 5, there is no vertical load platform motion when the cam rollers 18, 20 are at a point along the cam roller bearing surfaces 46, 48 represented by the right end of curve 49.

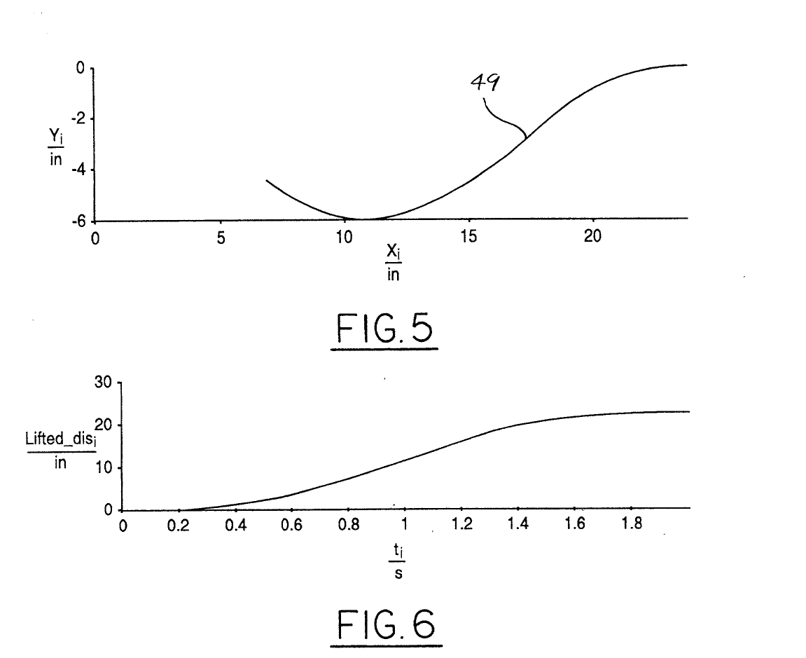

As shown in the above mathemical expressions and in the graphs shown in FIGS. 5 and 6, a cycloidal curve has no vertical or Y component at its beginning or at its end. Instead, a cycloidal curve has a significant vertical component at its midpoint. As a result, with the load platform 12 in a lowered position and the scissor linkages 14, 15 in their collapsed positions, as the cam follower rollers 18, 20 begin to be driven into the cams 22, 24, no vertical movement is imparted to the scissor linkages 14, 15. The cams 22, 24 are therefore shaped to allow the drive motor 28 to accelerate to synchronous speed before causing the drive motor 28 to bear the load of extending the scissor linkages 14, 15 and raising the load platform 12.

As the cam followers 18, 20 are driven further along the cams 22, 24, the scissor linkages 14, 15 begin to extend slowly, then more rapidly, then slowly again as the scissor linkages 14, 15 reach their respective fully extended positions. This allows the load platform 12 to start and stop smoothly, without vibration, despite the fact that the scissor linkages 14, 15 are being driven by a relatively simple constant-speed ball screw drive.

The shape of the cams 22, 24 also allows the drive motor 28 to continue running at a normal operating speed after the scissor linkages 14, 15 have been fully extended. This allows the drive motor 28 to be turned off and the brake 30 applied after the scissor linkage 14 and load platform 12 motions have stopped. This reduces brake wear and increases the life of the braking system. It also supports the load on the load platform 12 without requiring the aid of motor power, i.e., allowing the motor 28 to be shutoff and halting electrical power consumption.

The cams 22, 24 are shaped to translate the constant linear speed input from the carriage 42 to a cycloidal lift input to the load platform 12. Cycloidal motion is sometimes referred to as “soft touch” motion because it allows the load platform 12 to start and stop its lifting motion without shaking or jarring a workpiece supported on the load platform 12.

An outer limit switch, shown at 58 in FIGS. 1-4, turns the drive motor 28 off once the platform 12 has reached a desired height and the carriage 42 reaches an outer limit of its travel. The outer limit switch 58 is mounted on the base 32 of the lifter 16 and is actuated by the carriage 42 when the carriage 42, which is also mounted on the base 32, reaches its outer limit. The outer limit switch 58 is tripped by a trip dog adjustably carried by a rod or arm fixed to the carriage.

The scissor linkages 14, 15 are likewise supported on the base 32. Each scissor linkage 14, 15 includes two pairs of pivotally interconnected crossed scissor arms or links 60, 64; 62, 66. In other embodiments there may be only a single pair of crossed scissor arms or more than two pair of crossed scissor arms connected together in a vertical series.

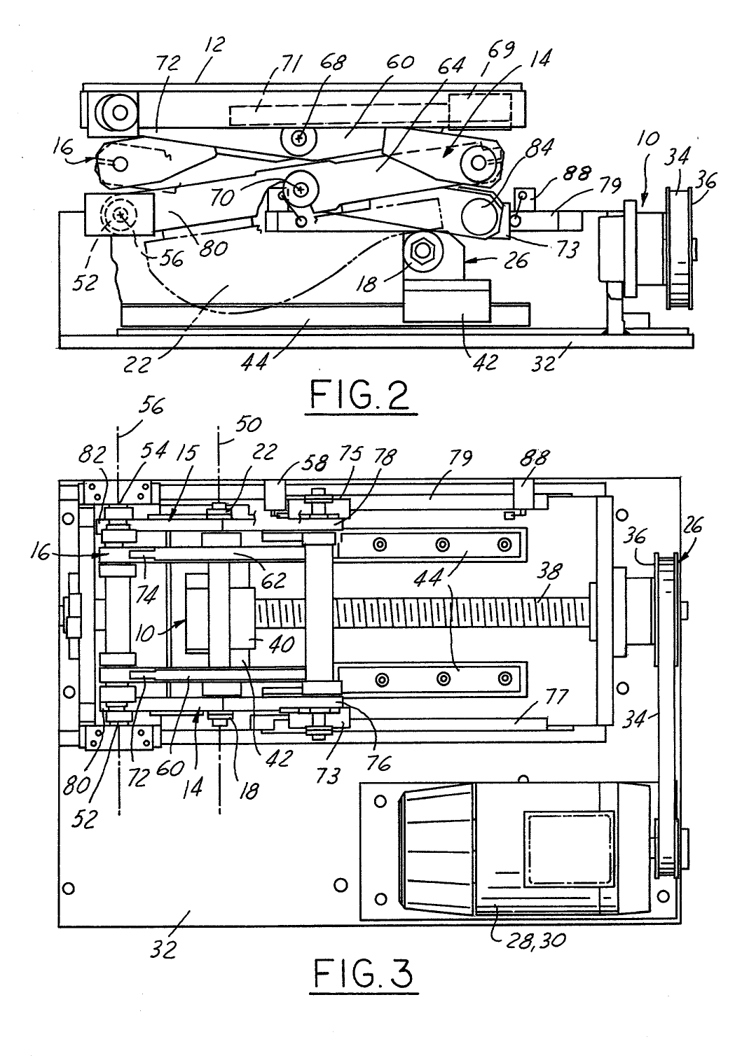

The two crossed arms of each scissor arm pair 60, 64; 62, 66 are connected together at respective approximate midpoints for pivotal movement about a common scissor axis 68, 70. Uppermost scissor arm pairs 60, 62 of the two scissor linkages 14, 15 share an upper scissor axis 68 of the two scissor axes 68, 70. Lowermost scissor arm pairs 64, 66 of the two scissor linkages 14, 15 share a lower scissor axis 70 of the two scissor axes 68, 70. An upper end 72, 74 of one of the arms of the crossed scissor arms of the uppermost scissor arm pair 60, 62 of each scissor linkage 14, 15 is pivotally connected to the load platform 12. An upper end 76, 78 of the other arm of the crossed scissor arms of the uppermost scissor arm pair 60, 62 of each scissor linkage 14, 15 is connected to and supported on the load platform 12 for horizontal reciprocal sliding movement toward and away from the upper end of the pivotally connected arm and perpendicular to the upper scissor axis 68. As best shown in FIGS. 2 and 4, the upper ends 76, 78 are pivotally connected to respective slides 69. The slides 69 are supported for horizontal sliding movement along horizontally oriented ways 71 that are fixed to the platform 12.

A lower end 80, 82 of one arm of the crossed scissor arms of the lowermost scissor arm pair 64, 66 of each linkage 14, 15 (which may be the same as the uppermost pair 62, 64 where the linkages 14, 15 each include only one scissor arm pair) is pivotally connected to the base 32. A lower end, 84, 86 of the other arm of the crossed scissors arms of the lowermost scissor arm pair 64, 66 of each linkage 14, 15 is supported on the base 32 for horizontal reciprocal sliding movement toward and away from the lower end 80, 82 of the pivotally connected arms of the lowermost scissor arm pair 64, 66 and perpendicular to the lower scissor axis 70. The lower ends 84, 86 are pivotally connected to slides 73, 75 that are slidably supported on a pair of horizontally disposed ways 77, 79.

The platform 12 is raised and lowered by moving the horizontally slidable ends 76, 78; 84, 86 of each scissor arm pair 60, 64; 62, 66 of each scissor linkage 14, 15 toward and away from the pivotally connected ends 72, 74; 80, 82 of each scissor arm pair 60, 64; 62, 66, respectively, thus extending and collapsing the scissor linkages 14, 15 in unison.

The cams 22, 24 are mounted on the arms of the lowermost scissor arm pairs 64, 66 of the linkages 14, 15 that are pivotally connected to the base 32.

The position of the cam followers 18, 20 relative to the cams 22, 24 controls the angular position of the arms of the scissor arm pairs 60, 64; 62, 66 which in turn controls the lifted distance of the load platform 12 as shown graphically in FIG. 6 and mathematically in the following equations:

Lifted_{—dis=}R·(ω·t−sin(ω·t))

where:

$$R = \frac{Lift\_height}{2 \cdot π}$$

which is the radius of an imaginary roller, where Lift_height is the overall height of the lift platform at maximum extension; and

$$ω = \frac{2 \cdot π}{Lift\_Time}$$

which is the angular velocity of the imaginary roller (in a vertical direction as defined by cycloidal motion).

In practice, the apparatus 10 can be used to lift a workpiece positioned on the load platform 12 by first actuating the motor 28. When the motor 28 is actuated, the motor brake 30 disengages and the motor 28 accelerates to synchronous speed while turning the belt and pulley system and driving the ball screw 38. As the motor 28 accelerates to synchronous speed the ball screw 38 drives the ball screw nut 40 and therefore the carriage 42 forward linearly along the ways 44. The cam followers 18, 20 act on the respective cams 22, 24 but initially produce no lifting motion. This is because the initial portion of the cycloidal cam curve 49 defined by each of the cam follower bearing surfaces 46, 48 includes no vertical component. Once the motor 28 has reached synchronous speed, the cam followers 18, 20 reach respective portions of the cycloidally curved cam follower bearing surfaces 46, 48 that include progressively larger lift components and begin extending the scissor arm linkages 14, 15 and raising the load platform 12. As the carriage 42 reaches the outermost extent of its travel, the upward motion of the load platform 12 decelerates and then stops while the motor 28 continues running at synchronous speed. The motor 28 continues to run at synchronous speed and the carriage 42 continues to move horizontally until the carriage 42 contacts and actuates the outer limit switch 58. The outer limit switch 58 turns off the motor 28 which automatically engages the motor brake 30 locking the motor 28, ball screw 38, carriage 42, cam followers 18, 20, scissor linkages 14, 15 and load platform 12 in position.

To reverse the apparatus 10, the motor 28 is actuated to rotate in reverse direction and accelerates to a reverse synchronous speed as it begins retracting the carriage 42 by turning the ball screw 38 in reverse. The cycloidal shape of the curved cam follower bearing surfaces 46, 48 of the cams 22, 24 allows the motor 28 to reach synchronous speed before the scissor linkages 14, 15 begin to collapse and the load platform 12 begins to descend. As the carriage 42 reaches the fully retracted position, the collapse of the scissor linkages 14, 15 and the descent of the load platform 12 decelerate to a stop as the motor 28 continues running at synchronous speed. The motor 28 continues to run at synchronous speed and continues to retract the carriage 42 horizontally until the carriage 42 reaches the innermost limit of its travel and contacts an inner limit switch 88 supported on the base 32. Actuation of the inner limit switch 88 turns off the motor 28 and automatically engages the motor brake 30.

This description is intended to illustrate certain embodiments of the invention rather than to limit the invention. Therefore, it uses descriptive rather than limiting words. Obviously, it's possible to modify this invention from what the description teaches. Within the scope of the claims, one may practice the invention other than as described.

What is claimed is:

1. A scissors lifter drive apparatus for raising and lowering a load platform by extending and collapsing a scissors linkage, the apparatus comprising:
a scissors lifter including a load platform supported for reciprocal vertical movement on a first scissor linkage, the platform being raisable and lowerable by extending and collapsing the first scissor linkage;
a first cam mounted on the first scissor linkage in a position to be drivingly engaged by a first cam follower, the first cam being positioned and shaped to gradually accelerate extension of the first scissor linkage;
the first cam follower being supported for generally horizontal reciprocal motion and being drivingly engageable with the first cam to extend the first scissor linkage;
a drive connected to the first cam follower and configured to move the first cam follower through generally horizontal reciprocal motion; and
the first cam is shaped to allow the drive to accelerate to an optimum desired operating speed before causing the drive to bear the load of extending the first scissor linkage and raising the load platform.

2. A scissors lifter drive apparatus as defined in claim 1 in which:
the drive includes a drive motor coupled to the first cam follower and configured to move the first cam follower through generally horizontal reciprocal motion;
the apparatus includes a brake configured to hold the load platform at whatever elevation the load platform is in when the drive motor is turned off; and
the cam is shaped to allow the drive motor to continue running at a desired operating speed after the first scissor linkage has been fully extended.

3. A scissors lifter drive apparatus as defined in claim 2 in which the brake is configured to engage the brake whenever the drive motor is turned off and to disengage the brake whenever the drive motor is turned on.

4. A scissors lifter drive apparatus as defined in claim 1 in which the drive is configured to impart a cycloidal lift motion to the lift platform.

5. A scissors lifter drive apparatus as defined in claim 4 in which the cam includes a cam follower bearing surface having a shape configured to produce cycloidal load platform motion.

6. A scissors lifter drive apparatus as defined in claim 1 in which:
the drive includes a constant-speed drive motor; and
the cam is shaped to allow the drive motor to accelerate to synchronous speed before causing the drive motor to bear the load of extending the first scissor linkage and raising the load platform.

7. A scissors lifter drive apparatus as defined in claim 1 in which:
the first scissor linkage includes at least one pair of crossed scissor arms;
the two crossed arms of each scissor arm pair are connected together at respective approximate midpoints for pivotal movement about a common scissor axis;
an upper end of a first one of the arms of the crossed scissor arms of an uppermost scissor arm pair of the first scissor linkage is pivotally connected to the load platform;
the upper end of a second arm of the crossed scissor arms of the uppermost scissor arm pair of the first scissor linkage being connected to and supported on the load platform for horizontal reciprocal movement toward and away from the upper end of the first arm and perpendicular to the scissor axis;
a lower end of a second arm of the crossed scissor arms of a lowermost scissor arm pair of the linkage is pivotally connected to a base;
a lower end of a first arm of the crossed scissor arms of the lowermost scissor arm pair is supported on the base for horizontal reciprocal movement toward and away from the lower end of the second arm of the lowermost scissor arm pair and perpendicular to the scissor axis;
the platform being raised and lowered by moving the horizontally slidable ends of each scissor arm pair of the first scissor linkage toward and away from pivotally connected ends of each scissor arm pair, respectively, thus extending and collapsing the first scissor linkage; and
the cam is mounted on the first arm of the first scissor linkage in a position to be drivingly engaged by the first cam follower.

8. A scissors lifter drive apparatus as defined in claim 1 in which:
the first cam follower is supported on a carriage for generally horizontal reciprocal motion; and
the drive is drivingly connected to the carriage and is configured to move the carriage and the first cam follower through generally horizontal reciprocal motion.

9. A scissors lifter drive apparatus as defined in claim 1 in which:
the scissors lifter includes a second scissor linkage disposed parallel to the first scissor linkage;
the load platform is supported for reciprocal vertical movement on the first and second scissor linkages;
the platform is raised and lowered by extending and collapsing the two scissor linkages in unison;
the apparatus includes a second cam, mounted on the second scissor linkage in a position to be drivingly engaged by a second cam follower, the second cam being disposed and shaped to gradually accelerate and decelerate extension of the second scissor linkage in parallel with the first scissor linkage;
the rolling cam follower being supported for generally horizontal reciprocal motion and being drivingly engageable with the second cam to extend the second scissor linkage; and
the drive is connected to the second cam follower and is configured to move the second cam follower through generally horizontal reciprocal motion in unison with the first cam follower.

10. A scissors lifter drive apparatus for raising and lowering a load platform by extending and collapsing a scissors linkage, the apparatus comprising:
a scissors lifter including a load platform supported for reciprocal vertical movement on a scissor linkage, the platform being raised and lowered by extending and collapsing the scissor linkage;
a cam mounted on the scissor linkage in a position to be drivingly engaged by a cam follower, the cam being positioned and shaped to gradually accelerate and decelerate scissor linkage extension;
the cam follower being supported for generally horizontal reciprocal motion and being drivingly engageable with the cam to extend the scissor linkage;
a drive motor operably coupled to the cam follower and configured to move the cam follower through generally horizontal reciprocal motion;
the apparatus includes a brake configured to hold the load platform at whatever elevation the load platform is in when the drive motor is turned off; and
the cam is shaped to allow the drive motor to continue running at a normal operating speed after the first scissor linkage has been fully extended.

11. A scissors lifter drive apparatus as defined in claim 10 in which the brake is configured to engage the brake whenever the drive motor is turned off and to disengage the brake whenever the drive motor is turned on.
